(19) United States
(12) Patent Application Publication
(10) Pub. No.: US 2004/0021571 A1
(43) Pub. Date: Feb. 5, 2004

(54) Talking mailbox device

(76) Inventor: Edward Kido Kim, Upland, CA (US)

Correspondence Address: Edward Kido Kim, 421 E. 25th Street, Upland, CA, 91784, US

(21) Appl. No.: 10/207,356

(22) Filed: Jul. 30, 2002

(51) Int. Cl. G08B 13/14

(52) U.S. Cl. 340/569

(57) ABSTRACT

The device is a small rectangular electronic device. The device consists of a photosensitive sensor to detect light, a speaker to play short audio clips, and an internal electronic board that stores one hundred different short audio clips of jokes and witty remarks pertaining to the postal service and mailmen/women. The device is to be placed inside a mailbox. Whenever the mailbox is opened and light strikes the photosensitive sensor, the mailbox will “talk” to the mailman/woman or mailbox owner by means of the device choosing among its one hundred audio clips to play.

### CROSS REFERENCE

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The job of a mailman/woman can often become monotonous and lonely, especially when the delivery route is very long. These employees oftentimes desire a companion from time to time to tell them a joke or witty remark to bring about a smile or good laugh.

Mailboxes throughout the world are cold and inanimate objects. The owner of a mailbox pays little attention to his/her mailbox. Turning the mailbox into an animated and humorous entity would add more fun and humor to the life of the mailbox owner.

### BRIEF SUMMARY OF THE INVENTION

A small rectangular electronic device that can be placed in a mailbox will remedy the boredom by telling a joke or humorous comment pertinent the delivery and retrieval of mail. The device will be able to detect whenever the mailbox is being opened and will, at this instant, “talk” to the mailman/woman or mailbox owner by playing a joke or witty comment concerning the delivery and retrieval of mail.

### BRIEF DESCRIPTION OF SEVERAL VIEWS OF THE DRAWINGS VIEWS

FIG. 1 shows a frontal view of the device.

FIG. 2 shows a top view of the device.

FIG. 3 shows a side view of the device.

FIG. 4 shows how the device is used.

FIG. 5 shows a flowchart for describing the operation of the device.

### COMPONANTS

1a) Front casing

1b) Back casing

2) Photosensitive sensor

3) Speaker

### DETAILED DESCRIPTION OF THE INVENTION

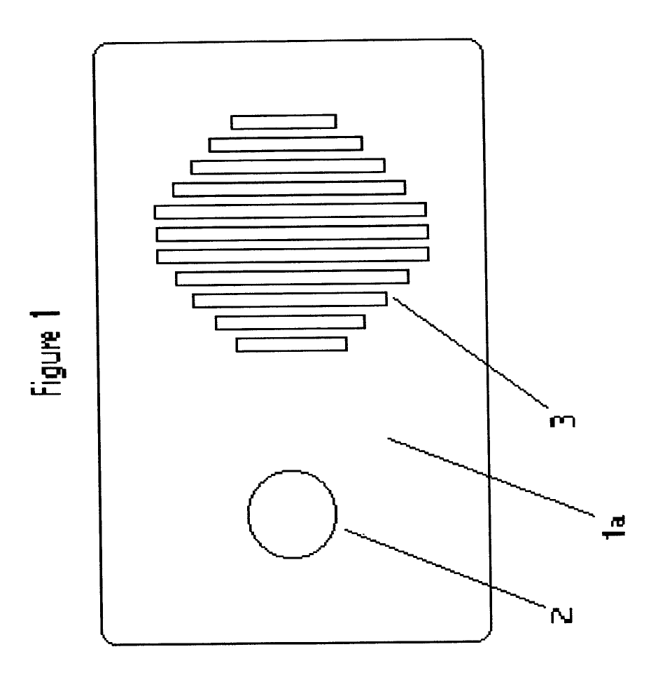

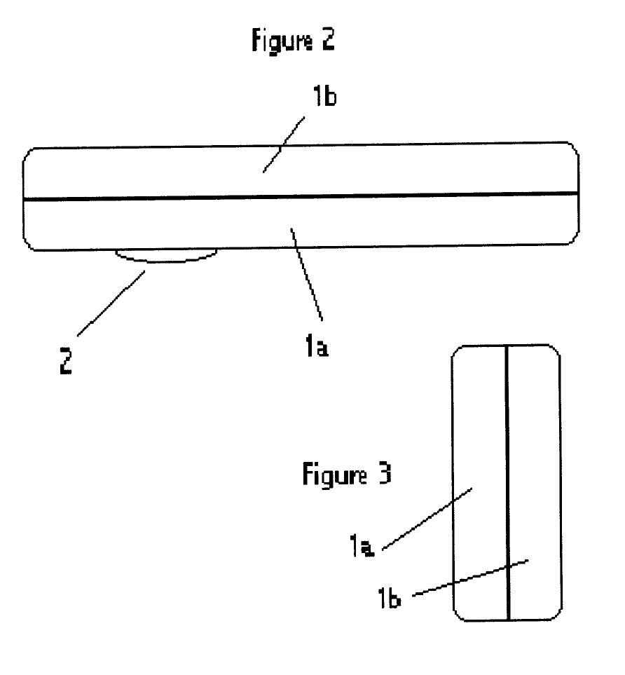

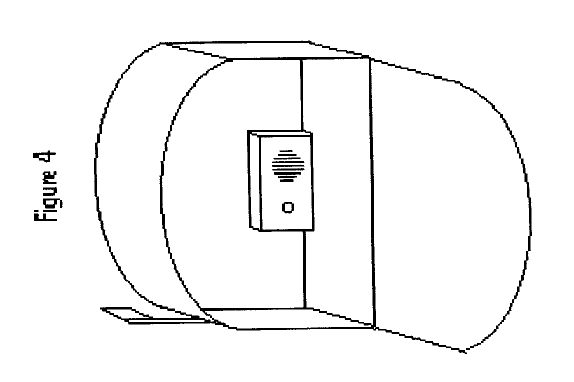

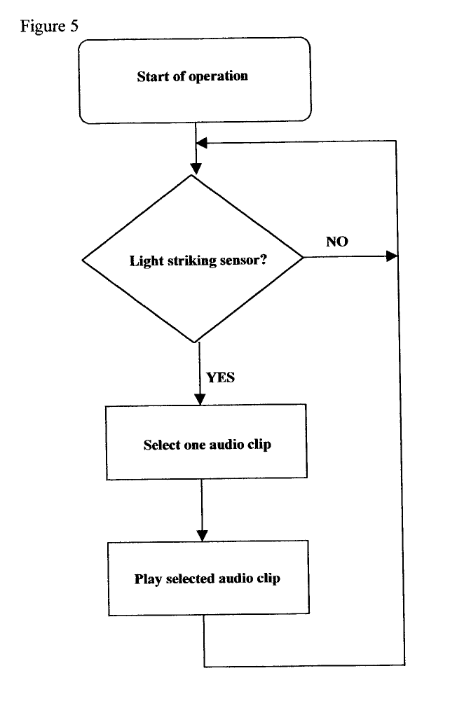

The device illustrated in FIGS. 1, 2, and 3 is used to give any mailbox the ability to talk. The device illustrated in FIGS. 1, 2, and 3 has a rectangular casing, which encloses a photosensitive sensor (component 1), a speaker (component 2), and an electronic board that controls the device (not shown in drawings). As illustrated in FIG. 4, the said device is used by placing it inside a mailbox along the back wall so that it does not deter the mailbox's ability to hold mail.

The front casing of the said device contains a round transparent section. behind which exists the photosensitive sensor, so that light may enter through the front casing and strike the sensor. Additionally, the front casing of the said device contains holes, behind which exists the speaker, so that sound may exit the front casing with minimal disturbance.

The electronic board contains one hundred short audio clips of jokes and witticisms pertaining to the delivery and retrieval of mail. Examples of the stored audio clips can include “Please, no bills!” and “My, what nice hands you have!” and “Mailmen deliver mail, but do mailwomen deliver fe-mail?”

When the mailbox is opened, light from the sun will enter the mailbox and strike the photosensitive sensor. This will prompt the electronic board to select and play from one of its one hundred stored audio clips. The mailbox, with the ability to “talk” by using the said device, will tell the mailman/woman or mailbox owner a joke or witticism as he/she is delivering or retrieving mail. After playing one audio clip, the said device will remain quiet until the next time that light strikes its photosensitive sensors.

We claim:

1) A device consisting of:
A photosensitive sensor for detecting when the mailbox is opened.
An electronic board to store one hundred different audio clips of jokes or witticisms pertinent to the postal service and mailmen/women.
A speaker for playing the audio clips.
A front and back rectangular casing to enclose all the aforementioned components of this claim.

2) A device according to claim 1, wherein:
The said device is to be placed inside of any mailbox, so that the said device will give the mailbox in which it is placed the ability to “talk” by selecting and playing one of the one hundred different audio clips through its speakers whenever the mailbox is opened.
